(19) United States
(12) Patent Application Publication
(10) Pub. No.: US 2022/0092909 A1
(43) Pub. Date: Mar. 24, 2022

(54) BLACKJACK POKER GAME INSURANCE DISPLAY APPARATUS

(71) Applicant: Shu Yi Huang, Hsinchu (TW)

(72) Inventor: Shu Yi Huang, Hsinchu (TW)

(21) Appl. No.: 17/029,055

(22) Filed: Sep. 23, 2020

(51) Int. Cl. G07F 17/32

(52) U.S. Cl. CPC G07F 17/323; G07F 17/3211; G07F 17/3293; G07F 17/3244

(57) ABSTRACT

A BlackJack poker game insurance display apparatus includes a first display unit for outputting a point of an opened poker card of the dealer; a second display unit for outputting a sum of total points of the poker cards of the player; a third display unit for outputting odds based one the point of an opened poker card of the dealer and the total points of poker cards of the player; wherein when the total points the poker cards of the dealer is not Blackjack, the player can buy insurance; an odds decision machine connected to the third display unit for determining the odds in the third display unit; and wherein the odds are determined based on algorithms that can calculate in time or based on a table stored in the odds decision machine.

### FIELD OF THE INVENTION

The present invention is related to pokers, and in particular to a BlackJack poker game insurance display apparatus.

### BACKGROUND OF THE INVENTION

Playing games by using pokers are frequently amusements in human society. In many poker games, the possibility for outputting specific poker cards is based on the surplus poker cards not be outputted. The surplus poker cards are calculated from the original poker cards subtracting the outputted poker cards. However, conventionally, the surplus poker cards are recorded by human memory, but this is a big burden for peoples.

In Blackjack poker game, one of the first two poker cards of the dealer is opened, and the other is covered. The player can draw (hit) poker cards as desired. When the player considers that the dealer (bank) has a very high probability to win the game, and the total points of the player is also very high, for example, points of 18, 19, 20, 21), then the person having higher possibility to lose the game can provide a part of the wager as a bet. If in this game, the person buying the insurance has lost the game, the person can acquire a compensation to reduce the lost in this game. Generally, the compensation is an odds of the wager, while the odds is based on the points of the poker cards of the dealer or the players and the succeeding poker cards outputted.

Indeed, the odds are calculated based on the points of the poker cards of the dealer or the players and the succeeding poker cards outputted. However, if the odds are calculated manually in time, it is not practical and is a big burden. Therefore, conventionally, there are many tools which are used to assist the provision of the odds in one gambling, but these tools are not completely replaced the manual work, there are some works which also need people to operate.

Therefore, the present invention desires to provide a novel way in that the odds are preset based on the assemblies of the points of the dealer or the player. No calculation is needed. Therefore, those in games need not remember outputted poker cards in the games and need not speculate the points of the surplus poker cards so as to improve the defects in the prior art.

### SUMMARY OF THE INVENTION

Accordingly, for improving above mentioned defects in the prior art, the object of the present invention is to provide a BlackJack poker game insurance display apparatus, wherein the odds are displayed directly based on the points of the dealer and player. Therefore, the players and dealers are not necessary to remember the poker cards distributed or to speculate the surplus poker cards. The process is made automatically, no human work is needed and it is a precise action, no error occurs and no human cheat can be made.

To achieve above object, the present invention provides a BlackJack poker game insurance display apparatus, which is used in determining odds when playing BlackJack of poker games; the apparatus comprising: an insurance odds display comprising: a first display unit for outputting a point of an opened poker card of the dealer; a second display unit for outputting a sum of total points of the poker cards of the player; a third display unit for outputting odds based one the point of an opened poker card of the dealer and the total points of poker cards of the player; wherein when the total points the poker cards of the dealer is not BlackJack which means that two poker cards of dealer includes an Ace (A) and one of the poker cards with points of 10, 11, 12 and 13, then the player can buy insurance; an odds decision machine connected to the third display unit for determining the odds in the third display unit; and wherein the odds are determined based on algorithms that can calculate in time or based on a table stored in the odds decision machine.

### BRIEF DESCRIPTION OF THE DRAWINGS

FIG. 1 is an element structure diagram of the present invention.

FIG. 2 shows an odd table according to the present invention.

FIG. 3 shows an application of the present invention.

FIG. 4 is a structural diagram the present invention.

FIG. 5 is another structural diagram of the present invention.

FIG. 6 is a further structural diagram of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

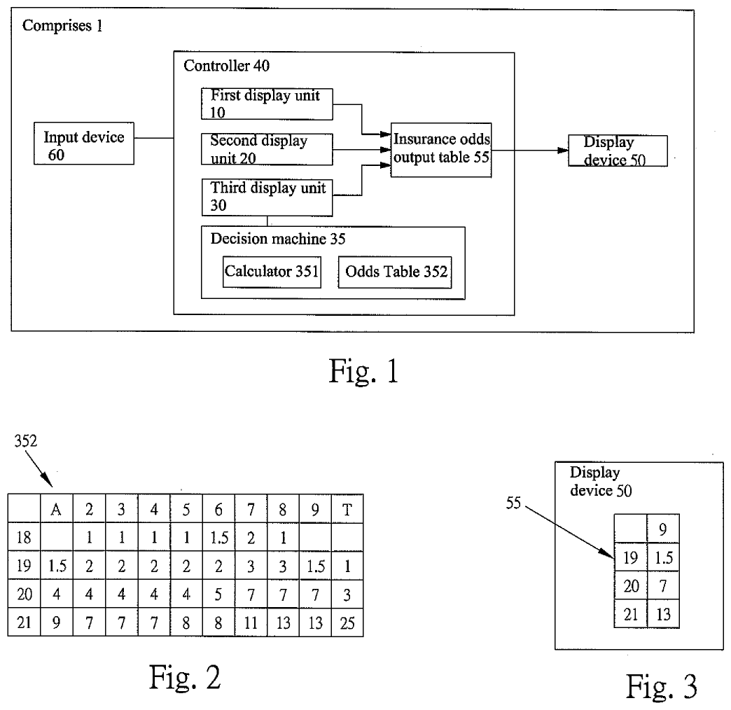

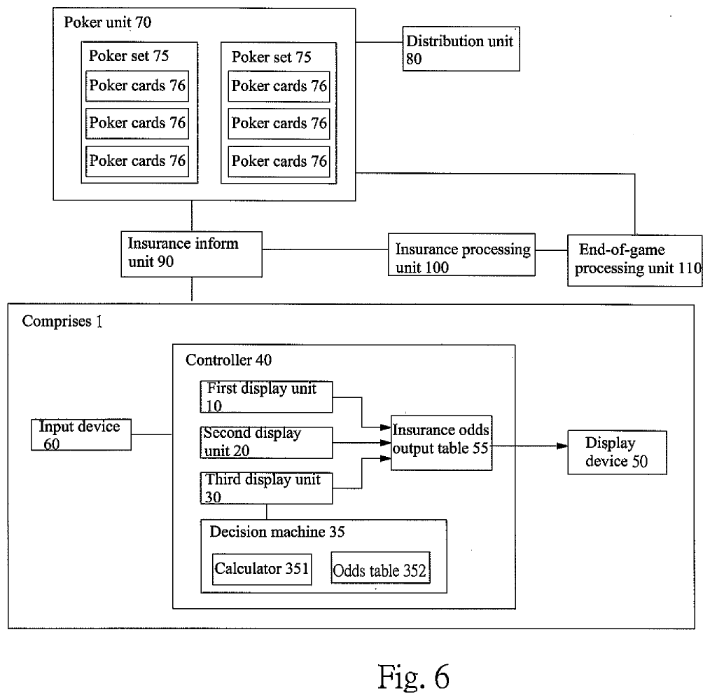

Referring to FIGS. 1 to 6, the structure of the present invention is illustrated. The present invention is mainly used in determining odds when playing BlackJack of poker games.

An insurance odds display 1 comprises:

A first display unit 10 serves to output the point of an opened poker card of the dealer.

A second display unit 20 serves for outputting the total points of the player.

A third display unit 30 serves for outputting the odds based one the point of an opened poker card of the dealer and the total points of the player.

When the total points of the dealer is not Blackjack, where the BlackJack means that two poker cards of dealer includes an Ace (A) and one of the poker cards with points of 10, 11, 12 and 13, then the player can buy insurance.

An odds decision machine 35 is connected to the third display unit 30 for determining the odds in the third display unit 30.

In the present invention, the odds are determined based on algorithms that can calculate in time or based on a table stored in the odds decision machine 35.

When the odds are calculated in time in the odds decision machine 35, the odds decision machine 35 includes a calculator 351 for calculating the odds. In the present invention, there are two ways for determining odds. The first way is based on the surplus poker cards which are not outputted, assuming that the original poker cards are known. By the surplus poker cards, the possibility for outputting specific poker cards in the following output is calculated and then the possibility for winning and losing in the gambling is calculated so as to determine the odds. The second way for determining the odds is based on the points of original poker cards which are emitted originally, that is, before any poker card is outputted. For example, in playing Blackjack, the poker cards with points of 1 to 9 have the same odds and the poker cards with points of 10 to 13 have the same odds.

Another, the odds decision machine 35 can decide an odds based on a preset table, the ways are as followings.

When the opened poker card of the dealer (bank) is A (Ace), as the sum of all the points of poker cards of the players is 19, the odds is 1.5; as the sum of all the points of poker cards of the players is 20, the odds is 4; as the sum of all the points of poker cards of the players is 21, the odds is 9.

When the opened poker card of the dealer (bank) is 2, as the sum of all the points of poker cards of the players is 18, the odds is 1; as the sum of all the points of poker cards of the players is 19, the odds is 2; as the sum of all the points of poker cards of the players is 20, the odds is 4; as the sum of all the points of poker cards of the players is 21, the odds is 7.

When the opened poker card of the dealer (bank) is 3, as the sum of all the points of poker cards of the players is 18, the odds is 1; as the sum of all the points of poker cards of the players is 19, the odds is 2; as the sum of all the points of poker cards of the players is 20, the odds is 4; as the sum of all the points of poker cards of the players is 21, the odds is 7.

When the opened poker card of the dealer (bank) is 4, as the sum of all the points of poker cards of the players is 18, the odds is 1; as the sum of all the points of poker cards of the players is 19, the odds is 2; as the sum of all the points of poker cards of the players is 20, the odds is 4; as the sum of all the points of poker cards of the players is 21, the odds is 7.

When the opened poker card of the dealer (bank) is 5, as the sum of all the points of poker cards of the players is 18, the odds is 1; as the sum of all the points of poker cards of the players is 19, the odds is 2; as the sum of all the points of poker cards of the players is 20, the odds is 4; as the sum of all the points of poker cards of the players is 21, the odds is 8.

When the opened poker card of the dealer (bank) is 6, as the sum of all the points of poker cards of the players is 18, the odds is 1.5; as the sum of all the points of poker cards of the players is 19, the odds is 2; as the sum of all the points of poker cards of the players is 20, the odds is 5; as the sum of all the points of poker cards of the players is 21, the odds is 8.

When the opened poker card of the dealer (bank) is 7, as the sum of all the points of poker cards of the players is 18, the odds is 2; as the sum of all the points of poker cards of the players is 19, the odds is 3; as the sum of all the points of poker cards of the players is 20, the odds is 7; as the sum of all the points of poker cards of the players is 21, the odds is 11.

When the opened poker card of the dealer (bank) is 8, as the sum of all the points of poker cards of the players is 18, the odds is 1; as the sum of all the points of poker cards of the players is 19, the odds is 3; as the sum of all the points of poker cards of the players is 20, the odds is 7; as the sum of all the points of poker cards of the players is 21, the odds is 13.

When the opened poker card of the dealer (bank) is 9, as the sum of all the points of poker cards of the players is 19, the odds is 1.5; as the sum of all the points of poker cards of the players is 20, the odds is 7; as the sum of all the points of poker cards of the players is 21, the odds is 13.

When the opened poker card of the dealer (bank) is T(T means that the point of the poker card is one of 10, 11, 12 and 13), as the sum of all the points of poker cards of the players is 19, the odds is 1; as the sum of all the points of poker cards of the players is 20, the odds is 3; as the sum of all the points of poker cards of the players is 21, the odds is 25.

With reference to FIG. 2, the relation for above mentioned is illustrated. All these relations are formed as an odds table 352 which is stored in the odds decision machine 35.

With reference to FIG. 1, the insurance odds display 1 further includes the following elements.

A controller 40 includes the first display unit 10, the second display unit 20 and the third display unit 30. The controller 40 forms an insurance odds output table 55 from the outputs of the first display unit 10, the first display unit 10 and the third display unit 30.

A display device 50 is connected to the controller 40 for displaying the insurance odds output table 55 from the controller 40.

An input device 60 is connected to the controller 40 for receiving the points of the dealer which is inputted manually or mechanically. When the input device 60 receives the points of the dealer and then the controller 40 will display the points of the dealers with the relation of the points of the players and the odds based on these relation. The odds are based on the insurance odds output table 55. For example, if the points of the dealer input to the input device 60 is 9, it will shows that as the sum of all the points of poker cards of the players is 19, the odds is 1.5; as the sum of all the points of poker cards of the players is 20, the odds is 7; as the sum of all the points of poker cards of the players is 21, the odds is 13.

Therefore, the player may decide if it is necessary to buy insurance.

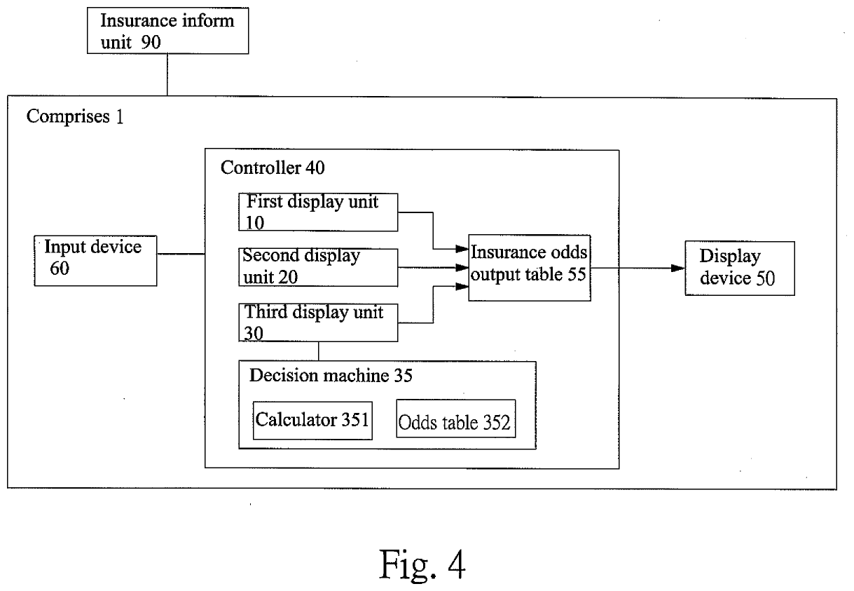

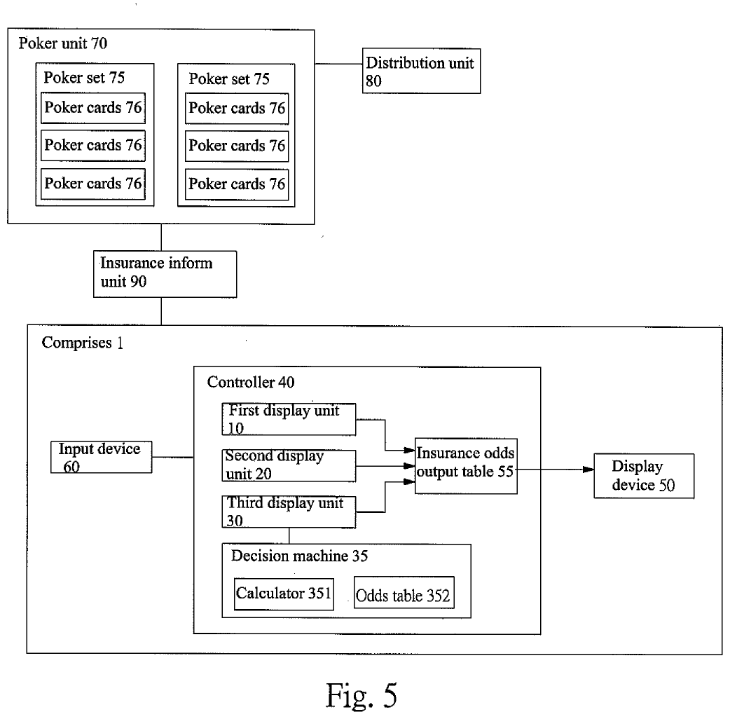

With reference to FIGS. 4 to 6, the present invention can be implemented as a compute game. The present invention further includes the following elements.

A poker unit 70 includes a plurality of poker card sets 75 for distribution. The poker unit 70 also records the surplus poker cards not distributed (dealt).

A distribution unit 80 is connected to the poker unit 70 for distributing poker cards 76 to the dealer and players. When poker cards are distributed to the dealer or the players, the poker unit 70 will change the record of the surplus poker cards.

An insurance inform unit 90 serves to inform and ask the player to decide to buy insurance.

The insurance inform unit 90 is connected to the poker unit 70 and the insurance odds display 1. When the condition of the player has to a state of buying insurance, the insurance inform unit 90 actuates the insurance odds display 1 so as to display respective odds based on the insurance odds output table 55 to the display device 50.

An insurance processing unit 100 is connected to the insurance inform unit 90 for receiving the instructions from the player to process relative actions.

An end-of-game processing unit 110 is connected to the poker unit 70 and the insurance processing unit 100 for calculating the game results as the game have come to an end. If the player has brought insurance, the end-of-game processing unit 110 also calculates the compensation to the player or to receive the insurance money of the player.

Advantages of the present invention are that the odds are displayed directly based on the points of the dealer and player. Therefore, the players and dealers are not necessary to remember the poker cards distributed or to speculate the surplus poker cards. The process is made automatically, no human work is needed and it is a precise action, no error occurs and no human cheat can be made.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A BlackJack poker game insurance display apparatus, which is used in determining odds when playing BlackJack of poker games; the apparatus comprising:
an insurance odds display comprising:
a first display unit for outputting a point of an opened poker card of the dealer;
a second display unit for outputting a sum of total points of the poker cards of the player;
a third display unit for outputting odds based one the point of an opened poker card of the dealer and the total points of poker cards of the player;
wherein when the total points the poker cards of the dealer is not BlackJack which means that two poker cards of dealer includes an Ace (A) and one of the poker cards with points of 10, 11, 12 and 13, then the player can buy insurance;
an odds decision machine connected to the third display unit for determining the odds in the third display unit; and
wherein the odds are determined based on algorithms that can calculate in time or based on a table stored in the odds decision machine.

2. The BlackJack poker game insurance display apparatus as claimed in claim 1, wherein when the odds are calculated in time in the odds decision machine, the odds decision machine includes a calculator for calculating the odds; the calculation is based on the surplus poker cards which are not outputted, assuming that the original poker cards are known; by the surplus poker cards, the possibility for outputting specific poker cards in the next distribution of poker cards is calculated and then the possibility for winning and losing in the game is calculated so as to determine the odds.

3. The BlackJack poker game insurance display apparatus as claimed in claim 1, wherein when the odds are calculated in time in the odds decision machine, the odds decision machine includes a calculator for calculating the odds; the calculation is based on points of original poker cards which are distributed originally, that is, before any poker card is outputted.

4. The BlackJack poker game insurance display apparatus as claimed in claim 1, wherein the odds decision machine decides an odds based on a preset table, the ways are as followings:
when the opened poker card of the dealer (bank) is A (Ace), as the sum of all the points of poker cards of the players is 19, the odds is 1.5; as the sum of all the points of poker cards of the players is 20, the odds is 4; as the sum of all the points of poker cards of the players is 21, the odds is 9;
when the opened poker card of the dealer (bank) is 2, as the sum of all the points of poker cards of the players is 18, the odds is 1; as the sum of all the points of poker cards of the players is 19, the odds is 2; as the sum of all the points of poker cards of the players is 20, the odds is 4; as the sum of all the points of poker cards of the players is 21, the odds is 7;
when the opened poker card of the dealer (bank) is 3, as the sum of all the points of poker cards of the players is 18, the odds is 1; as the sum of all the points of poker cards of the players is 19, the odds is 2; as the sum of all the points of poker cards of the players is 20, the odds is 4; as the sum of all the points of poker cards of the players is 21, the odds is 7;
when the opened poker card of the dealer (bank) is 4, as the sum of all the points of poker cards of the players is 18, the odds is 1; as the sum of all the points of poker cards of the players is 19, the odds is 2; as the sum of all the points of poker cards of the players is 20, the odds is 4; as the sum of all the points of poker cards of the players is 21, the odds is 7;
when the opened poker card of the dealer (bank) is 5, as the sum of all the points of poker cards of the players is 18, the odds is 1; as the sum of all the points of poker cards of the players is 19, the odds is 2; as the sum of all the points of poker cards of the players is 20, the odds is 4; as the sum of all the points of poker cards of the players is 21, the odds is 8;
when the opened poker card of the dealer (bank) is 6, as the sum of all the points of poker cards of the players is 18, the odds is 1.5; as the sum of all the points of poker cards of the players is 19, the odds is 2; as the sum of all the points of poker cards of the players is 20, the odds is 5; as the sum of all the points of poker cards of the players is 21, the odds is 8;
when the opened poker card of the dealer (bank) is 7, as the sum of all the points of poker cards of the players is 18, the odds is 2; as the sum of all the points of poker cards of the players is 19, the odds is 3; as the sum of all the points of poker cards of the players is 20, the odds is 7; as the sum of all the points of poker cards of the players is 21, the odds is 11;
when the opened poker card of the dealer (bank) is 8, as the sum of all the points of poker cards of the players is 18, the odds is 1; as the sum of all the points of poker cards of the players is 19, the odds is 3; as the sum of all the points of poker cards of the players is 20, the odds is 7; as the sum of all the points of poker cards of the players is 21, the odds is 13;
when the opened poker card of the dealer (bank) is 9, as the sum of all the points of poker cards of the players is 19, the odds is 1.5; as the sum of all the points of poker cards of the players is 20, the odds is 7; as the sum of all the points of poker cards of the players is 21, the odds is 13; and
when the opened poker card of the dealer (bank) is T(T means that the point of the poker card is one of 10, 11, 12 and 13), as the sum of all the points of poker cards of the players is 19, the odds is 1; as the sum of all the points of poker cards of the players is 20, the odds is 3; as the sum of all the points of poker cards of the players is 21, the odds is 25; and
wherein all the odds are formed as an odds table which is stored in the odds decision machine.

5. The BlackJack poker game insurance display apparatus as claimed in claim 1, further comprising:
a controller having the first display unit, the second display unit and the third display unit; the controller forming an insurance odds output table from the outputs of the first display unit, the first display unit and the third display unit;
a display device connected to the controller for displaying the insurance odds output table from the controller; and
an input device connected to the controller for receiving the points of the dealer which is inputted manually or mechanically; when the input device receives the points of the dealer and then the controller will display the points of the dealers with the relation of the points of the players and the odds based on these relation; the odds are based on the insurance odds output table.

6. The BlackJack poker game insurance display apparatus as claimed in claim 5, further comprising:
an insurance inform unit for informing and asking the player to decide whether it is necessary to buy insurance;
wherein the insurance inform unit is connected to the poker unit and the insurance odds display; when the condition of the player is in a state of buying insurance, the insurance inform unit actuates the insurance odds display so as to display respective odds based on the insurance odds output table to the display device.

7. The BlackJack poker game insurance display apparatus as claimed in claim 6, wherein further comprising:
a poker unit including a plurality of poker card sets to be distributed and the poker unit also recording the surplus poker cards not distributed; and
a distribution unit connected to the poker unit for distributing poker cards to the dealer and players; when poker cards are distributed to the dealer or the players, the poker unit changes the record of the surplus poker cards.

8. The BlackJack poker game insurance display apparatus as claimed in claim 5, further comprising:
an insurance processing unit connected to the insurance inform unit for receiving the instructions from the player to process relative actions;
an end-of-game processing unit connected to the poker unit and the insurance processing unit for calculating the game results as the game have come to an end; wherein if the player has brought insurance, the end-of-game processing also calculates the compensation to the player or to receive the insurance money of the player.

9. The BlackJack poker game insurance display apparatus as claimed in claim 1, wherein there are only one dealer and there is one or a plurality of players.
